(19) United States
(12) Patent Application Publication
(10) Pub. No.: US 2025/0088971 A1
(43) Pub. Date: Mar. 13, 2025

(54) METHODS AND DEVICES FOR CONTROLLING TRANSMISSION POWER

(71) Applicant: ZTE Corporation, Shenzhen (CN)

(72) Inventors: Xing LIU, Shenzhen (CN); Shuaihua KOU, Shenzhen (CN); Xianghui HAN, Shenzhen (CN); Xingguang WEI, Shenzhen (CN); Jing SHI, Shenzhen (CN); Jian LI, Shenzhen (CN)

(73) Assignee: ZTE Corporation, Shenzhen (CN)

(21) Appl. No.: 18/956,275

(22) Filed: Nov. 22, 2024

Related U.S. Application Data
(63) Continuation of application No. PCT/CN2022/111234, filed on Aug. 9, 2022.

(51) Int. Cl. H04W 52/14; H04W 52/36

(52) U.S. Cl. CPC H04W 52/14; H04W 52/367

(57) ABSTRACT

The present disclosure describes methods, system, and devices for controlling transmission power. One method includes performing, by a user equipment (UE), transmission power control for uplink (UL) transmission by: receiving, by the UE, a message corresponding to the transmission power control; determining, by the UE, a power control parameter according to the message; and transmitting, by the UE, the UL transmission with a transmission power according to the power control parameter. Another method includes configuring, by a base station, transmission power control for UL transmission by: transmitting, by the base station to a UE, a message corresponding to the transmission power control, so that the UE is configured to determine a power control parameter according to the message; and receiving, by the base station from the UE, the UL transmission with a transmission power according to the power control parameter.

### TECHNICAL FIELD

The present disclosure is directed generally to wireless communications. Particularly, the present disclosure relates to methods and devices for controlling transmission power.

### BACKGROUND

Wireless communication technologies are moving the world toward an increasingly connected and networked society. In wireless communication system, time domain resource is split between downlink and uplink communications. An emerging trend in mobile communications is the parallel usage of multiple radio technologies. When there are both uplink and downlink communications in different frequency domain resource of a same time domain resource, cross-link interference for the time-frequency resources may occur, hindering the performance of the wireless communication.

The present disclosure describes various embodiments for controlling transmission power, addressing at least one of issues/problems associated with cross-link interference for the time-frequency resources, providing improvement in the technology field of wireless communication and increasing its efficiency and performance.

### SUMMARY

This document relates to methods, systems, and devices for wireless communication, and more specifically, for controlling transmission power. The various embodiments in the present disclosure may be beneficial to effectively counteract/decrease the inter-subband interference, to increase resource utilization efficiency, and to boost performance of the wireless communication.

In one embodiment, the present disclosure describes a method for wireless communication. The method includes performing, by a user equipment (UE), transmission power control for uplink (UL) transmission by: receiving, by the UE, a message corresponding to the transmission power control; determining, by the UE, a power control parameter according to the message; and transmitting, by the UE, the UL transmission with a transmission power according to the power control parameter.

In one embodiment, the present disclosure describes a method for wireless communication. The method includes configuring, by a base station, transmission power control for uplink (UL) transmission by: transmitting, by the base station to a user equipment (UE), a message corresponding to the transmission power control, so that the UE is configured to determine a power control parameter according to the message; and receiving, by the base station from the UE, the UL transmission with a transmission power according to the power control parameter.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of cross-link interference.

FIG. 2 shows an example of a network node.

FIG. 3 shows an example of a user equipment.

FIG. 4 shows a schematic diagram of a roll-off filter effect.

FIG. 5A shows a flow diagram of a method for wireless communication.

FIG. 5B shows a flow diagram of another method for wireless communication.

FIG. 6 shows a schematic diagram of a non-limiting embodiment for wireless communication.

FIG. 7 shows a schematic diagram of another non-limiting embodiment for wireless communication.

FIG. 8 shows a schematic diagram of another non-limiting embodiment for wireless communication.

FIG. 9 shows a schematic diagram of another non-limiting embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for controlling transmission power.

Next generation (NG), or 5th generation (5G), wireless communication may provide a range of capabilities from downloading with fast speeds to support real-time low-latency communication. New generation (NG) mobile communication system are moving the world toward an increasingly connected and networked society. To meet more and more demands, the 4th Generation mobile communication technology (4G) Long-Term Evolution (LTE) or LTE-Advance (LTE-A) and the 5G mobile communication technology are developing supports on features of enhanced mobile broadband (eMBB), ultra-reliable low-latency communication (URLLC), and massive machine-type communication (mMTC). Full duplex is one of the developed feature for 5G and further communication system.

In some implementations of a wireless communication system, the time domain resource is split between downlink and uplink in time division duplex (TDD). Allocation of a limited time duration for the uplink in TDD would result in reduced coverage, increased latency and reduced capacity. As a possible enhancement on this limitation of the conventional TDD operation, it may be worth implementing the feasibility of allowing the simultaneous existence of downlink and uplink, a.k.a. full duplex, or more specifically, subband non-overlapping full duplex (SBFD) at a base station side (e.g., gNB) within a conventional TDD band. There may be both uplink and downlink in different frequency domain resource of a same time domain resource.

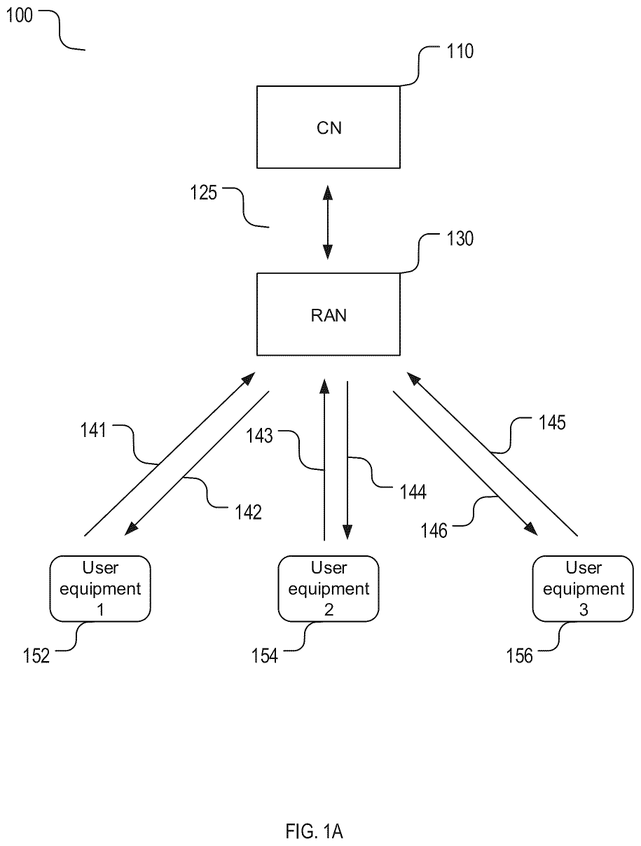

For a non-limiting example, referring to FIG. 1B, for a same cell under the base station, there are two different frequency resource with different frame structures (e.g., for slot 0, slot 1, slot 2, slot 3, and slot 4), one (161) is DDDSU, another (162) is DSUUU, wherein D represents ‘downlink’, U represents ‘uplink’, and S represents ‘flexible resource’. These frame structures may be further updated according to dynamic scheduling or dynamic frame structure indication (e.g., slot format indicator (SFI)). Then, during the middle three time intervals (e.g., slot 1, slot 2, and slot 3) may be different attributes between different frequency resources. For different UEs, the base station may transmit physical downlink shared channel (PDSCH) and receive physical uplink shared channel (PUSCH) simultaneously, for example, the base station transmits PDSCH to one UE (UE1) at slot 2, and simultaneously receives PUSCH from another UE (UE2). Under these circumstances, there may be cross-link interference for the time-frequency resources with different attributes of frame structure. Specifically, the downlink transmission of one gNB (i.e., PDSCH in FIG. 1B) may interfere with the uplink reception (i.e., PUSCH in FIG. 1B), that is, the downlink interference to the uplink. This interference may be referred as gNB self-interference under SBFD.

In some implementations of a wireless communication system, the time domain resource is split between downlink and uplink in time division duplex (TDD). Allocation of a limited time duration for the uplink in TDD would result in reduced coverage, increased latency and reduced capacity. As a possible enhancement on this limitation of the conventional TDD operation, it may be worth implementing the feasibility of allowing the simultaneous existence of downlink and uplink in neighbouring cells. Then, the uplink transmission may also be interfered by downlink transmission in neighbouring cell. It can be called as inter-gNB co-channel interference. There may be both uplink and downlink in adjacent frequency domain resource of a same time domain resource. Then, the interference uplink transmission may also be interfered by downlink transmission in adjacent channel from neighbouring cell. The interference can also be called as inter-gNB adjacent channel interference.

The present disclosure describes methods and devices for controlling, e.g., transmission power, addressing at least one of the issues/problems associated with cross-link interference, and/or enhancing the uplink transmission performance with gNB self-interference or inter-gNB interference.

FIG. 1A shows a wireless communication system 100 including a core network (CN) 110, a radio access network (RAN) 130, and one or more user equipment (UE) (152, 154, and 156). The RAN 130 may include a wireless network base station, or a NG radio access network (NG-RAN) base station or node, which may include a nodeB (NB, e.g., a gNB) in a mobile telecommunications context. In one implementation, the core network 110 may include a 5G core network (5GC), and the interface 125 may include a new generation (NG) interface.

Referring to FIG. 1A, a first UE 152 may wirelessly receive one or more downlink communication 142 from the RAN 130 and wirelessly send one or more uplink communication 141 to the RAN 130. Likewise, a second UE 154 may wirelessly receive downlink communication 144 from the RAN 130 and wirelessly send uplink communication 143 to the RAN 130; and a third UE 156 may wirelessly receive downlink communication 146 from the RAN 130 and wirelessly send uplink communication 145 to the RAN 130. For example but not limited to, a downlink communication may include a physical downlink shared channel (PDSCH) or a physical downlink control channel (PDCCH), and a uplink communication may include a physical uplink shared channel (PUSCH) or a physical uplink control channel (PUCCH).

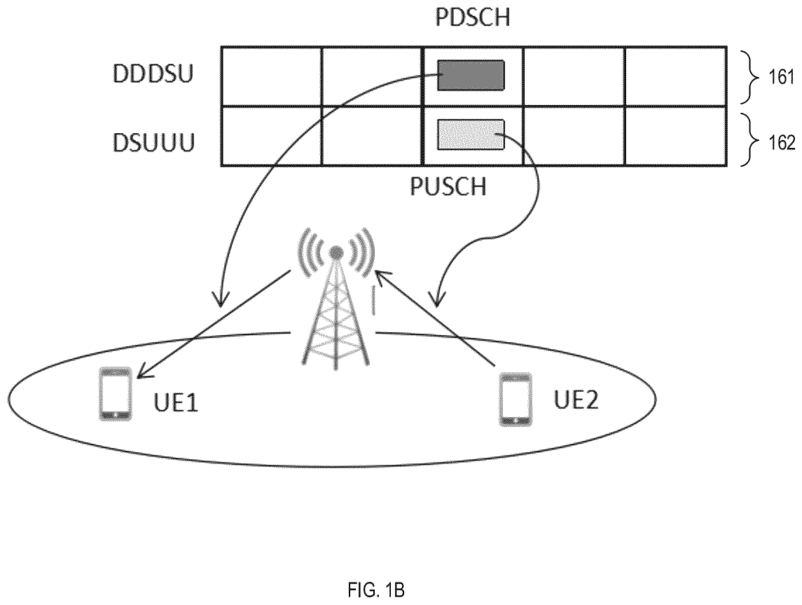

FIG. 2 shows an exemplary a radio access network or a wireless communication base station 200. The base station 200 may include radio transmitting/receiving (Tx/Rx) circuitry 208 to transmit/receive communication with one or more UEs, and/or one or more other base stations. The base station may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

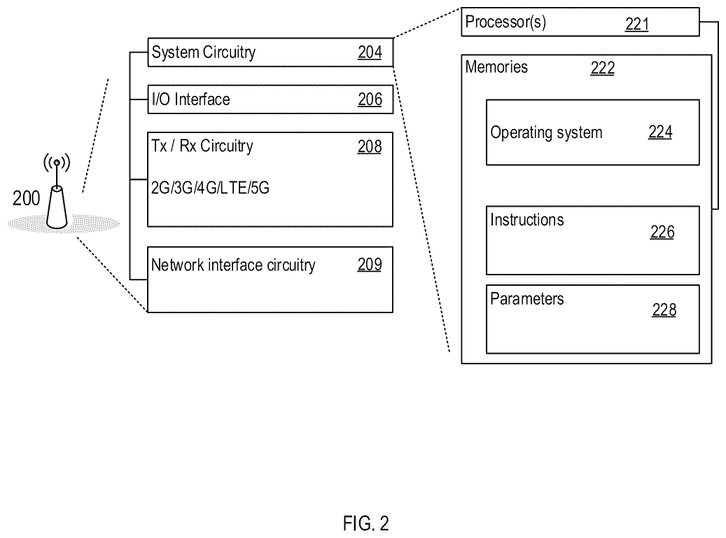

FIG. 3 shows an exemplary user equipment (UE) 300. The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several embodiments of methods and devices for controlling transmission power, which may be implemented, partly or totally, on the wireless network base station and/or the user equipment described above in FIGS. 2 and 3.

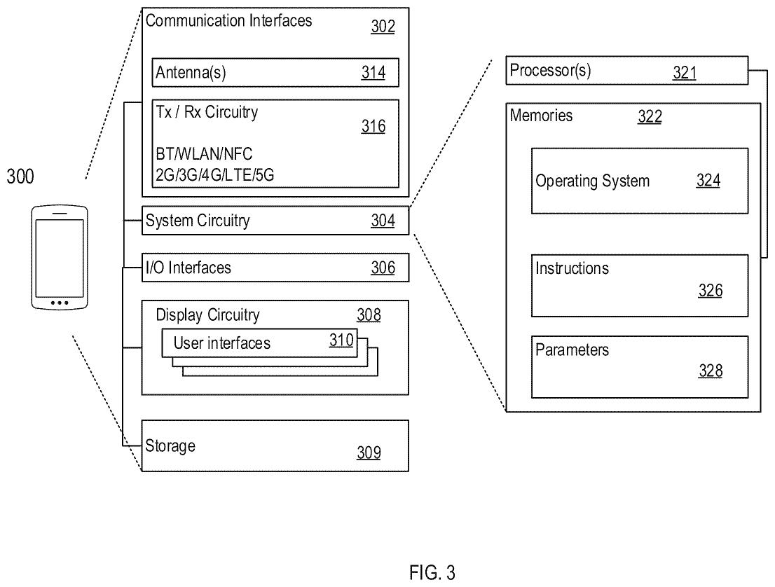

In various embodiments, referring to FIG. 4, signals need to be filtered before transmitting over the air so that signals can be restricted within the desired frequency range. The desired frequency range may be a range between f−B/2 and f+B/2 (410), wherein f is a central frequency and B is a bandwidth. Ideally, after filtering, there should be no leakage signal out of the desired frequency range. However, due to the limitation of technology and implementation complexity, there are always leakage signals out of the desired frequency range. Typically, output of signals after the filter may be shown as the example in FIG. 4. For desired signal with centre frequency at f and with bandwidth B, the leakage signal within bandwidth B that is adjacent to the desired signal (i.e., from f−3B/2 to f−B/2 (420) and from f+B/2 to f+3B/2 (425)) is stronger than the leakage signal with bandwidth B that is further away from the desired signal (e.g., from f−5B/2 to f−3B/2 (430) and from f+3B/2 to f+5B/2 (435)). Meanwhile, the leakage signal within bandwidth B that is adjacent to the desired signal is more dynamic. The leakage signal may be the interference to the desired signal within frequency resource from f−5B/2 to f−B/2 and from f+B/2 to f+5B/2. This may be referred as “roll-off filter”.

At least due to the roll-off filter effect, the uplink transmission within a UL subband, such as PUSCH, may be interfered by DL transmission within a DL subband adjacent to one side or both sides. This type of interference can be called as a gNB self-interference or an inter-subband interference.

The present disclosure describes several embodiments of methods and devices for controlling transmission power, addressing at least some of the issues/problems associated with the interference described above, wherein the uplink transmission power control mechanism may be enhanced for counteracting such interference. In various embodiments, the uplink transmission power control mechanism may include at least one of the following: using proper power control parameter set, introducing power adjustment factor, changing the maximum transmission power limit, and etc.

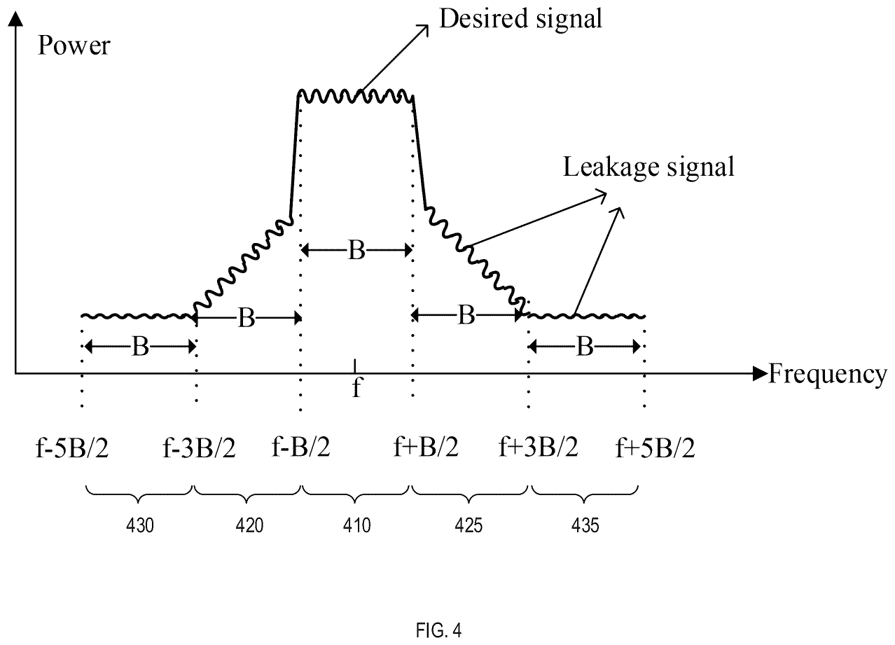

In various embodiments, FIG. 5A shows a flow diagram of a method 500 for wireless communication including performing, by a user equipment (UE), transmission power control for uplink (UL) transmission. The method 500 may include a portion or all of the following steps: step 510, receiving, by the UE, a message corresponding to the transmission power control; step 520, determining, by the UE, a power control parameter according to the message; and/or step 530, transmitting, by the UE, the UL transmission with a transmission power according to the power control parameter.

In various embodiments, FIG. 5B shows a flow diagram of a method 550 for wireless communication including configuring, by a base station, transmission power control for uplink (UL) transmission. The method 550 may include a portion or all of the following steps: step 560: transmitting, by the base station to a user equipment (UE), a message corresponding to the transmission power control, so that the UE is configured to determine a power control parameter according to the message; and/or step 570, receiving, by the base station from the UE, the UL transmission with a transmission power according to the power control parameter.

In some implementations, in additional to a portion or a combination of the described implementations/embodiments, the power control parameter comprises one of the following: a power control parameter set, a power adjustment factor, or a maximum power limit; and/or the power control parameter set comprises at least one of the following: an open-loop power control parameter set, or a closed-loop power control parameter set.

In some implementations, in additional to a portion or a combination of the described implementations/embodiments, the UL transmission comprises a physical uplink shared channel (PUSCH) in a UL resource.

In some implementations, in additional to a portion or a combination of the described implementations/embodiments, the message corresponding to the transmission power control comprises at least one of the following: a radio resource control (RRC) message, a medium access control (MAC) layer signaling, or a downlink control information (DCI) message.

In some implementations, in additional to a portion or a combination of the described implementations/embodiments, the message comprises at least one configuration parameter comprising at least one of the following: a downlink (DL) subband bandwidth, a DL transmission power, a frequency offset, an adjacent channel leakage power ratio (ACLR), an adjacent channel selectivity (ACS), an adjacent channel interference power ratio (ACIR), an interference quantity leaking from a reference point, a decreasing interference quantity per frequency unit, and/or a ratio between a frequency resource of the UL transmission and a frequency resource of the UL subband.

In some implementations, in additional to a portion or a combination of the described implementations/embodiments, the UE determine the power control parameter according to the at least one configuration parameter in the message.

In some implementations, in additional to a portion or a combination of the described implementations/embodiments, the UE derives an interference quantity for the UL transmission based on the at least one configuration parameter in the message; and/or the UE determines the power control parameter according to the interference quantity or interference level for the UL transmission.

In some implementations, in additional to a portion or a combination of the described implementations/embodiments, when the UE derives the interference quantity or interference level for the UL transmission based on the at least one configuration parameter in the message: the UE derives the interference quantity or interference level for the UL transmission based on at least one interference quantity at at least one reference point, at least one decreasing interference quantity per frequency unit corresponding to the at least one reference point, and at least one offset frequency unit between the UL transmission and the at least one reference point.

In some implementations, in additional to a portion or a combination of the described implementations/embodiments, the at least one offset frequency unit is determined based on the at least one reference point and one of the following: a frequency of a lowest resource block (RB) of the UL transmission, a frequency of a lowest resource element (RE) of the UL transmission, a frequency of a highest RB of the UL transmission, a frequency of a highest RE of the UL transmission, a frequency of a center RB of the UL transmission, and/or a frequency of a center RE of the UL transmission.

In some implementations, in additional to a portion or a combination of the described implementations/embodiments, the UE determines more than one reference RB or RE in the UL transmission, and determines the largest interference quantity among the more than one reference RB or RE as the interference quantity for the UL transmission.

In some implementations, in additional to a portion or a combination of the described implementations/embodiments, when the UE determines the power control parameter according to the interference quantity for the UL transmission: the UE compares the interference quantity for the UL transmission with at least one threshold to determine the power control parameter according to a comparison result.

In some implementations, in additional to a portion or a combination of the described implementations/embodiments, when the UE determines the power control parameter according to the interference quantity for the UL transmission: the UE obtains N thresholds in ascending order and (N+1) values of power control parameters corresponding to (N+1) segments defined by the N thresholds, respectively, wherein N is a positive integer; in response to the interference quantity for the UL transmission being smaller than a first threshold in the N thresholds, the UE determines a first value in the (N+1) values of the power control parameter; in response to the interference quantity for the UL transmission being equal to or larger than a n-th threshold and being smaller than a (n+1)-th threshold in the N thresholds, the UE determines a (n+1)-th value in the (N+1) values of the power control parameter, wherein n is a positive integer and smaller than N; and/or in response to the interference quantity for the UL transmission being equal to or larger than a N-th threshold in the N thresholds, the UE determines a (N+1)-th value in the (N+1) values of the power control parameter.

In some implementations, in additional to a portion or a combination of the described implementations/embodiments, the message corresponding to the transmission power control comprises a mapping between a plurality of resource set and a plurality of power control parameter.

In some implementations, in additional to a portion or a combination of the described implementations/embodiments, the mapping is a one-to-one mapping.

In some implementations, in additional to a portion or a combination of the described implementations/embodiments, the UE determines a resource set in which the UL transmission is located; and/or the UE determines a power control parameter corresponding to the resource set based on the mapping.

In some implementations, in additional to a portion or a combination of the described implementations/embodiments, the UE determines more than one resource sets in which the UL transmission is located; and/or the UE determines a power control parameter corresponding to a resource set in the more than one resource sets based on the mapping, wherein the resource set is one of the following: the resource set having a highest overlapping ratio with the UL transmission, and/or the resource set corresponding to a largest transmission power among the more than one resource sets.

In some implementations, in additional to a portion or a combination of the described implementations/embodiments, the message corresponding to the transmission power control comprises a field indicating whether the UE adjusts the transmission power of the UL transmission.

In some implementations, in additional to a portion or a combination of the described implementations/embodiments, the message comprises a DCI format or a random access response (RAR) UL grant; and/or the field comprises a 1-bit field.

In some implementations, in additional to a portion or a combination of the described implementations/embodiments, in response to the field indicating that the UE adjusts the transmission power of the UL transmission, the UE determines the transmission power of the UL transmission based on at least one of the following: a power adjustment factor, a power control parameter set, or a maximum power limit.

In some implementations, in additional to a portion or a combination of the described implementations/embodiments, the message corresponding to the transmission power control comprises at least one indication field, wherein each indication field of the at least one indication field indicates that a group of resource corresponding to the indication field is mapped with a transmission power adjustment.

In some implementations, in additional to a portion or a combination of the described implementations/embodiments, the transmission power adjustment comprises at least one of the following: a power adjustment factor, a power control parameter set, or a maximum power limit.

In some implementations, in additional to a portion or a combination of the described implementations/embodiments, the UE determines a group of resource in which the UL transmission is located; and/or the UE determines a mapped transmission power adjustment corresponding to the group of resource indicated by a corresponding indication field.

In some implementations, in additional to a portion or a combination of the described implementations/embodiments, the UE determines more than one groups of resource in which the UL transmission is located; and/or the UE determines a mapped transmission power adjustment corresponding to a group of resource among the more than one groups of resource indicated by a corresponding indication field, wherein the group of resource is one of the following: the group of resource having a highest overlapping ratio with the UL transmission, and/or the group of resource corresponding to a largest transmission power among the more than one groups of resource.

### Embodiment 1

The present disclosure describes non-limiting embodiments for uplink transmission power control for counteracting inter-subband interference. In various embodiments, one or more power adjustment factors may be introduced to further adjust UL transmit power, which is obtained based on the existing power control mechanism. In this way, the influence of inter-subband interference is reduced. Specifically, the power adjustment factor can be determined semi-statically or dynamically.

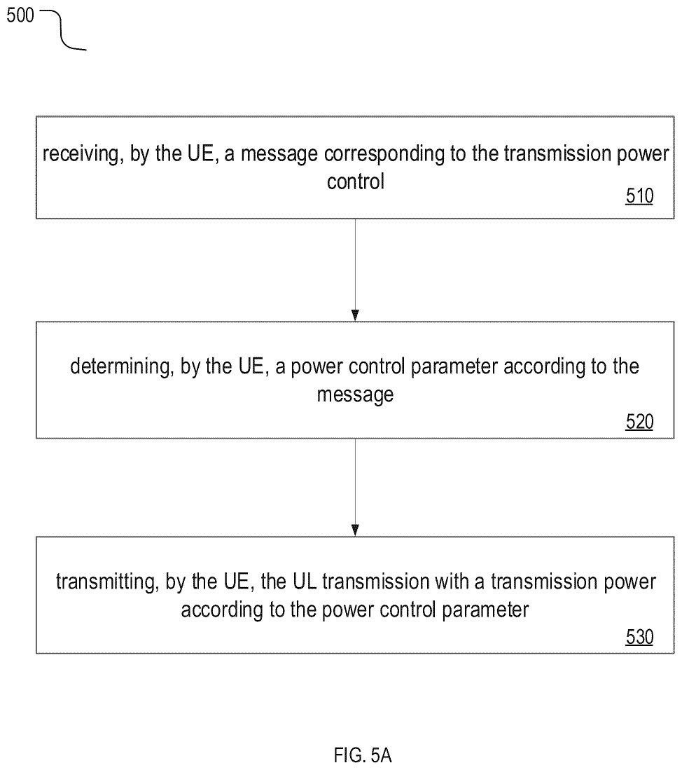

For a non-limiting example, referring to FIG. 6, the inter-subband interference may be described/expressed by a function. For example, the interference value at a target point (610) (e.g., A₀) may be determined according to the interference value at one or more reference points (620 and/or 630) (e.g., the spectrum edge of DL subband, i.e., A₁ and/or A₂) and corresponding one or more frequency offset between the target point and the reference point (N_{offset1} and/or N_{offset2}).

In some implementations, the interference value at the reference point is used as the initial value, and linear attenuation may be used for the frequency offset. Either of the target point or the reference point can be a center or boundary of a resource block (RB) or a resource element (RE).

Referring to FIG. 6, for the inter-subband interference caused by a low-frequency DL subband, e.g., the DL subband 1 (671), to a UL subband (672), the interference quantity leaked from the low-frequency DL subband at the reference point A₁ (for example, at the junction of the low-frequency DL subband/UL subband, or at the upper boundary of low-frequency DL subband, or at the lower boundary of UL subband) is I₁ dBm. The interference quantity is decreased by k₁ dB per frequency unit. The interference quantity at the target frequency point A₀ (N_{offset1} frequency units away from the reference point A₁) may be I_{low}=I₁−k₁×N_{offset1}.

Similarly, the interference caused by a high-frequency DL subband (673) to the UL subband may be I_{high}=I₂−k₂×N_{offset2}. I₂ is the interference leaked by the high-frequency DL subband at the reference point (for example, the junction of high-frequency DL subband/UL subband, or the lower boundary of high-frequency DL subband, or the upper boundary of UL subband), N_{offset2} is the number of frequency units between the target frequency point A₀ and the reference point A₂, and k₂ is the dB quantity of interference amount decreased per frequency unit. In some implementations, depending on the frequency of the subbands and operation conditions/environments, I₁ and I₂ may be different, and are not necessary the same. k₂ and k₂ may be different, and are not necessary the same. Then, at the target frequency point, the total quantity of inter-subband interference from both sides may be Iₜₒₜₐₗ=I_{low}+I_{high}.

In some implementations, the relationship between power adjustment factor (O) and total quantity of inter-subband interference Iₜₒₜₐₗ may be defined by a set of thresholds of the total quantity of inter-subband interference and a set of power adjustment factors. One non-limiting example is shown in Table 1 (or Table 2) with two thresholds and three power adjustment factors. Based on the calculation of Iₜₒₜₐₗ, and the relationship. A UE can get the corresponding power adjustment factor O. For calculation of Iₜₒₜₐₗ, gNB needs to provide the following parameters for the UE: I₁, k₁, I₂ and k₂.

TABLE 1
One example of relationship between Iₜₒₜₐₗ and 0

| | |
|---|---|
| Iₜₒₜₐₗ (dBm) | 0 (dB) |
| Iₜₒₜₐₗ < | 2 |
| I_{threshold1} | |
| I_{threshold1} ≤ | 4 |
| Iₜₒₜₐₗ < I_{threshold2} | |
| I_{threshold2} ≤ | 6 |
| Iₜₒₜₐₗ | |

TABLE 2
Another example of relationship between Iₜₒₜₐₗ and 0

| | |
|---|---|
| Iₜₒₜₐₗ | 0 (dB) |
| (dBm) | |
| Iₜₒₜₐₗ ≤ | 2 |
| I_{threshold1} | |
| I_{threshold1} < | 4 |
| Iₜₒₜₐₗ ≤ I_{threshold2} | |
| I_{threshold2} < | 6 |
| Iₜₒₜₐₗ | |

In some implementations, the power adjustment factor O may be determined by the maximum interference received on the uplink transmission. That is, the interference on each RB or RE occupied by an uplink transmission (e.g., PUSCH scheduled by DCI, PUSCH scheduled by RAR UL grant, configured grant PUSCH, PUCCH, SRS, etc.) is calculated according to one of methods described in the present disclosure, and then, the maximum value is determined as Iₜₒₜₐₗ, based on which the value of O is determined. One drawback with the above implementation may be that, there may be too many RBs or REs occupied by the uplink transmission, and/or determining Iₜₒₜₐₗ may be too complicated or time consuming for a UE.

In some implementations, for the sake of simplicity, some reference RBs or REs within the uplink transmission may be selected as the target frequency points for Iₜₒₜₐₗ calculation: for example, the lowest RB or RE of the uplink transmission, the highest RB or RE of the uplink transmission, or the central RB or RE of the uplink transmission. Any one of the above references RBs or REs may be defined as the target frequency point. In some implementations, multiple reference RBs or REs may be defined as the reference points for Iₜₒₜₐₗ calculation, and the maximum value is determined as the final Iₜₒₜₐₗ for determining the value of O.

In some implementations, there may be other parameters/functions for describing the inter-subband inference. At least one of the parameters for inter-subband interference calculation (e.g., I₁, k₁, I₂ and k₂) may be determined according to one or a combination of the other parameters/functions For example, some parameters/functions may be related to (or affect) the interference amount, e.g., DL subband bandwidth, DL transmission power, frequency offset between DL transmission and UL subband/uplink transmission, ACLR/ACS/ACIR, filter related parameters, antenna isolation, and etc. The related information may be provided from gNB to UE via either of RRC signaling, MAC layer signaling, or DCI.

Various embodiments present methods for uplink transmission power control for counteracting inter-subband interference. The method can effectively counteract the inter-subband interference, and flexibly match the requirements of coverage enhancement and capacity increase.

### Embodiment 2

The present disclosure describes another set of non-limiting embodiments for uplink transmission power control for counteracting inter-subband interference. In various embodiments, the relationship between Iₜₒₜₐₗ and power control parameters set may be defined. The power control parameters set contains open-loop power control parameter (e.g., P0, alpha) or closed-loop power control parameter (e.g., transmission power control (TPC) table). In some implementations, P0 represents a target reception power at a gNB side; and alpha represents a compensation coefficient of the path loss. A UE can determine the transmission power of an uplink transmission according to the P0, alpha, and path loss from its downlink measurement. In some implementations, the closed-loop power control parameter can be used for further adjusting the uplink transmission power, e.g., increasing or decreasing the power by some dBs according to a TPC command. More specifically in some implementations, a TPC table with four lines is defined, and each line comprises a power adjustment quantity, e.g., one value of −1, 0, 1, 3 dB. Then, the TPC command field with 2 bits are used (as an index) for indicating one line in the TPC table, and the corresponding value of power adjustment quantity may be used for adjusting the power of the uplink transmission.

In some implementations, the relationship between Iₜₒₜₐₗ and open-loop power control parameters set may be defined by a set of thresholds of the total quantity of inter-subband interference and a set of open-loop power control parameters sets. For a non-limiting example, referring to Table 3, the relationship between Iₜₒₜₐₗ and open-loop power control parameters set is defined with two thresholds and three open-loop power control parameters sets. In this example, there are N (e.g., N=3) open-loop power control parameters sets are defined, i.e., {P0, alpha}#1, {P0, alpha}#2 and {P0, alpha}#3; and N−1 thresholds are defined, i.e., I_{threshold1} and I_{threshold2}. In response to Iₜₒₜₐₗ<I_{threshold1}, {P0, alpha}#1 may be used for determining the uplink transmission power. In response to I_{threshold1}≤Iₜₒₜₐₗ<I_{threshold2}, {P0, alpha}#2 may be used for determining the uplink transmission power. In response to I_{threshold2}≤Iₜₒₜₐₗ, {P0, alpha}#3 may be used for determining the uplink transmission power.

For another non-limiting example, referring to Table 4, the relationship between Iₜₒₜₐₗ and open-loop power control parameters set is defined with two thresholds and three open-loop power control parameters sets. In this example, there are N (e.g., N=3) open-loop power control parameters sets are defined, i.e., {P0, alpha}#1, {P0, alpha}#2 and {P0, alpha}#3; and N-1 thresholds are defined, i.e., I_{threshold1} and I_{threshold2}. In response to Iₜₒₜₐₗ≤I_{threshold1}, {P0, alpha}#1 may be used for determining the uplink transmission power. In response to I_{threshold1}<Iₜₒₜₐₗ≤I_{threshold2}, {P0, alpha}#2 may be used for determining the uplink transmission power. In response to I_{threshold2}<Iₜₒₜₐₗ, {P0, alpha}#3 may be used for determining the uplink transmission power.

TABLE 3
One example of relationship between Iₜₒₜₐₗ
and open-loop power control parameters set

| Iₜₒₜₐₗ (dBm) | power control parameters set |
|---|---|
| Iₜₒₜₐₗ < I_{threshold1} | {P0, alpha}#1 |
| I_{threshold1} ≤ Iₜₒₜₐₗ < I_{threshold2} | {P0, alpha}#2 |
| I_{threshold2} ≤ Iₜₒₜₐₗ | {P0, alpha}#3 |

TABLE 4
Another example of relationship between Iₜₒₜₐₗ
and open-loop power control parameters set

| Iₜₒₜₐₗ (dBm) | power control parameters set |
|---|---|
| Iₜₒₜₐₗ < I_{threshold1} | {P0, alpha}#1 |
| I_{threshold1} < Iₜₒₜₐₗ ≤ I_{threshold2} | {P0, alpha}#2 |
| I_{threshold2} < Iₜₒₜₐₗ | {P0, alpha}#3 |

In some implementations, the relationship between Iₜₒₜₐₗ and closed-loop power control parameters set may be defined by a set of thresholds of the total quantity of inter-subband interference and a set of closed-loop power control parameters sets. For a non-limiting example, referring to Table 5, the relationship between Iₜₒₜₐₗ and closed-loop power control parameters set is defined. In this example, there are N (e.g., N=3) TPC tables are defined, i.e., TPC Table-1, TPC Table-2 and TPC Table-3; and N−1 thresholds are defined, i.e., I_{threshold1} and I_{threshold2}. In response to Iₜₒₜₐₗ<I_{threshold1}, TPC Table-1 may be used for determining the uplink transmission power. In response to I_{threshold1}≤Iₜₒₜₐₗ<I_{threshold2}, TPC Table-2 may be used for determining the uplink transmission power. In response to I_{threshold2}≤Iₜₒₜₐₗ, TPC Table-3 may be used for determining the uplink transmission power.

For another non-limiting example, referring to Table 6, the relationship between Iₜₒₜₐₗ and closed-loop power control parameters set is defined. In this example, there are N (e.g., N=3) TPC tables are defined, i.e., TPC Table-1, TPC Table-2 and TPC Table-3; and N−1 thresholds are defined, i.e., I_{threshold1} and I_{threshold2}. In response to Iₜₒₜₐₗ≤I_{threshold1}, TPC Table-1 may be used for determining the uplink transmission power. In response to I_{threshold1}<Iₜₒₜₐₗ≤I_{threshold2}, TPC Table-2 may be used for determining the uplink transmission power. In response to I_{threshold2}<Iₜₒₜₐₗ, TPC Table-3 may be used for determining the uplink transmission power.

TABLE 5
One example of relationship between Iₜₒₜₐₗ and
closed-loop power control parameters set

| Iₜₒₜₐₗ (dBm) | power control parameters set |
|---|---|
| Iₜₒₜₐₗ < I_{threshold1} | TPC Table-1 |
| I_{threshold1} ≤ Iₜₒₜₐₗ < I_{threshold2} | TPC Table-2 |
| I_{threshold2} ≤ Iₜₒₜₐₗ | TPC Table-3 |

TABLE 6
Another example of relationship between Iₜₒₜₐₗ
and closed-loop power control parameters set

| Iₜₒₜₐₗ (dBm) | power control parameters set |
|---|---|
| Iₜₒₜₐₗ ≤ I_{threshold1} | TPC Table-1 |
| I_{threshold1} < Iₜₒₜₐₗ ≤ I_{threshold2} | TPC Table-2 |
| I_{threshold2} < Iₜₒₜₐₗ | TPC Table-3 |

Various embodiment present methods for uplink transmission power control for counteracting inter-subband interference. The method can effectively counteract the inter-subband interference, and flexibly match the requirements of coverage enhancement and capacity increase.

### Embodiment 3

The present disclosure describes another set of non-limiting embodiments for uplink transmission power control for counteracting inter-subband interference. In various embodiments, multiple sets of resource may be configured via RRC signaling, and each set of resource is mapped with a power control parameter set. The power control parameters set contains open-loop power control parameter (e.g., P0, alpha) or closed-loop power control parameter (e.g., TPC table).

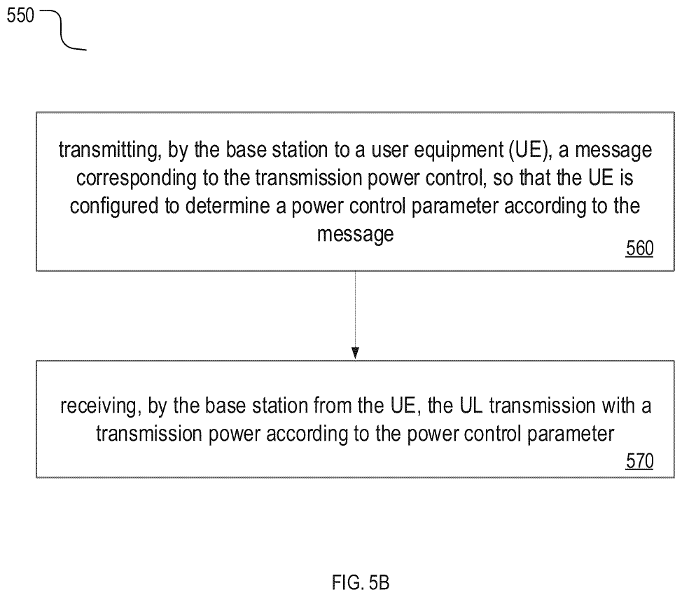

For a non-limiting example, referring to FIG. 7, three resource sets (710, 720, and 730) are defined/configured via the RRC signaling. Referring to Table 7, the relationship between the resource sets and the open-loop power control parameters sets is defined. In this example, there are N (e.g., N=3) open-loop power control parameters sets are defined, i.e., {P0, alpha}#1, {P0, alpha}#2 and {P0, alpha}#3; and three sets of resource (i.e., the first resource set, the second resource set and the third resource set) are defined accordingly. When the uplink transmission is located within the first resource set, {P0, alpha}#1 may be used for determining the uplink transmission power. When the uplink transmission is located within the second resource set, {P0, alpha}#2 may be used for determining the uplink transmission power. Else, when the uplink transmission is located within the third resource set, {P0, alpha}#3 may be used for determining the uplink transmission power.

In some implementations, when an uplink transmission is overlapping with at least two sets of resource, the transmission power may be calculated according this two power control parameter set, respectively, and a larger transmission power may be used for the uplink transmission.

In some implementations, when an uplink transmission is overlapping with at least two sets of resource, the set of power control parameters corresponding to the resource group with higher resource overlapping ratios may be used for determining the power of the uplink transmission.

TABLE 7
Example of relationship between resource set
and open-loop power control parameters set

| Resource set | power control parameters set |
|---|---|
| The first resource set | {P0, alpha}#1 |
| The second resource set | {P0, alpha}#2 |
| The third resource set | {P0, alpha}#3 |

In some implementations, similarly, the relationship between resource sets and closed-loop power control parameters sets may be defined. When an uplink transmission is located within a resource set, the transmission power of the uplink transmission may be determined according to the corresponding closed-loop power control parameter set. When an uplink transmission is overlapping with at least two sets of resource, the transmission power may be calculated according the two power control parameter sets, respectively, and a larger transmission power will be used for the uplink transmission.

Various embodiments present methods for uplink transmission power control for counteracting inter-subband interference. The method can effectively counteract the inter-subband interference, and flexibly match the requirements of coverage enhancement and capacity increase.

### Embodiment 4

The present disclosure describes another set of non-limiting embodiments for uplink transmission power control for counteracting inter-subband interference. In various embodiments, an indication field in a DCI format or a random access response (RAR) UL grant may be introduced for indicating whether to use an additional power adjustment factor, or whether to use a different power control parameter set, or whether to use a different maximum transmission power limit for determining the final transmission power of an uplink transmission scheduled by the DCI format or the RAR UL grant. The additional power adjustment factor or the different power control parameter set or the different maximum transmission power limit are used for determining the transmission power for counteracting inter-subband interference.

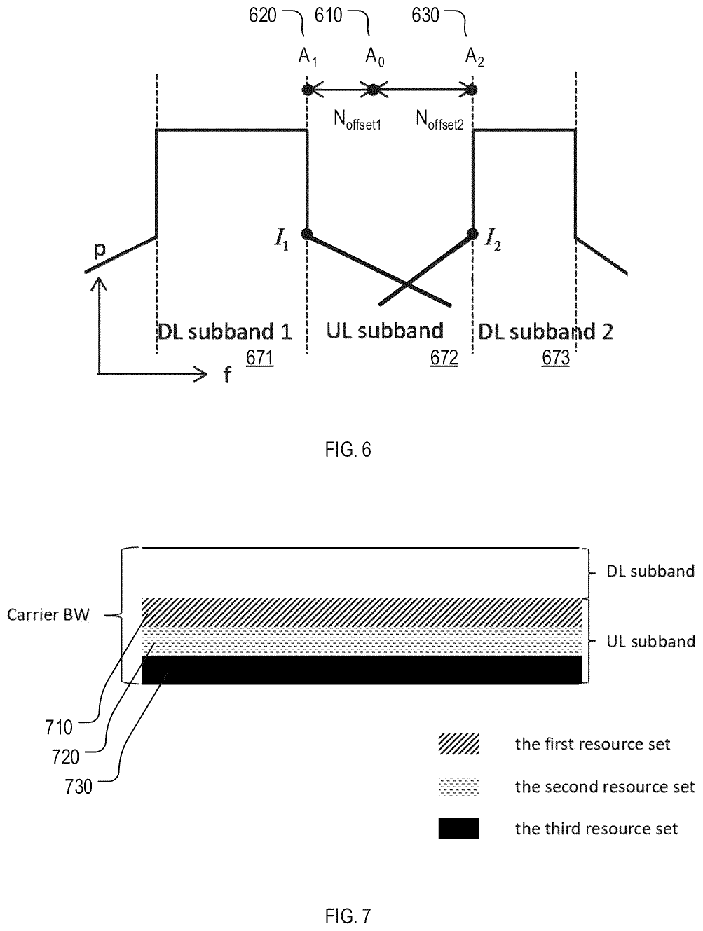

For a non-limiting example, referring to FIG. 8, two PDSCHs (811 and 812) are transmitted in a DL subband (810): a first PDSCH (PDSCH 1, 811) is located in symbol #4˜#6, and a second PDSCH (PDSCH 2, 812) is located in symbol #10˜#13. There may be additional inter-subband interference for uplink transmission in a UL subband (820) on symbols #4˜#6, #10˜#13.

There may be two PUSCHs (821 and 822) scheduled in a UL subband (820). For a second PUSCH (e.g., PUSCH 2 in symbol #11˜#13) being scheduled in these symbols in the UL subband, it may suffer the inter-subband interference from PDSCH (or PDSCH 2) in the DL subband, so that the indication field may indicate that an additional power adjustment factor or the different power control parameter set are used for determining the transmission power for counteracting inter-subband interference. While, for a first PUSCH (e.g., PUSCH 1 in symbol #7˜#9) being scheduled outside of these symbols, there may be no inter-subband interference, so that the indication field may indicate to determine the transmission power according to a normal power control parameter set.

Various embodiments present methods for uplink transmission power control for counteracting inter-subband interference. The method can effectively counteract the inter-subband interference, and flexibly match the requirements of coverage enhancement and capacity increase.

### Embodiment 5

The present disclosure describes another set of non-limiting embodiments for uplink transmission power control for counteracting inter-subband interference. In various embodiments, a group common DCI is defined, in which one or more resource indication field are included. Each of the resource indication field indicates a group of resource, and each group of resource is mapped with a set of power control parameter set or power adjustment factor or the maximum transmission power limit.

In some implementations, a UL subband may be divided into two groups of resources in the time domain. One group is the symbol that requires further power adjustment for counteracting inter-subband interference, and the other group is the symbol that does not require further power adjustment. It may be indicated in the form of bitmap. For example, a reference time-frequency resource may be defined, and the reference time-frequency resource may be further divided into some time frequency resource sub-block, each bit in the bitmap maps with a time-frequency resource sub-block. That is, the number of bits in the bitmap equals to number of sub-blocks in the reference time-frequency resource.

In some implementations, a predefined value (e.g., ‘1’) of the bit represents that the transmission power of an uplink transmission should be further adjusted when it at least partially overlaps with the corresponding sub-block. On the other hand, when a bit in the bitmap has another value (e.g., ‘0’), the transmission power of an uplink transmission should not be further adjusted when it only overlaps with the corresponding sub-block.

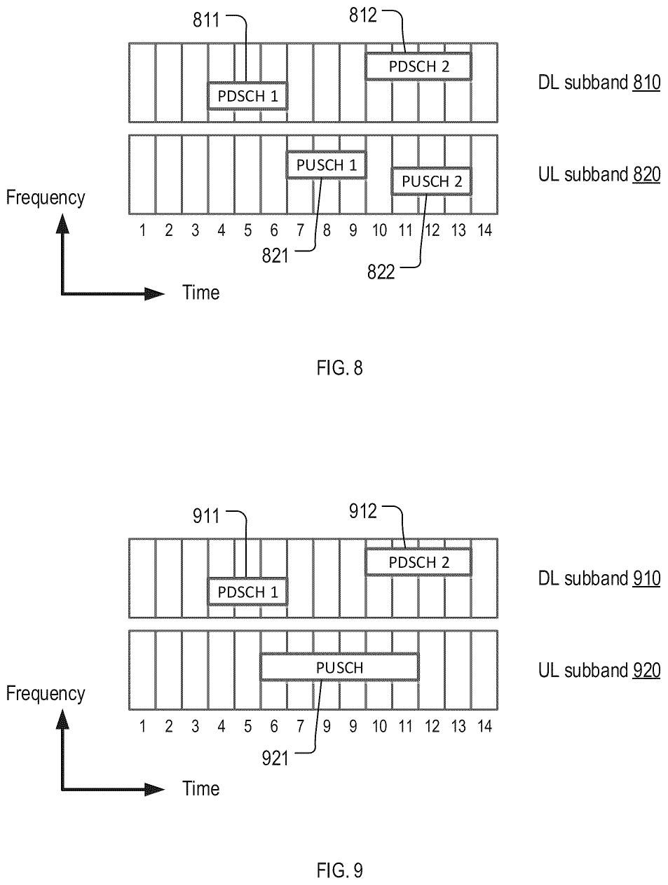

For a non-limiting example, referring to FIG. 9, the reference time-frequency resource is determined as a slot in time domain, and the bandwidth of UL subband in frequency. The Group common DCI contains a resource indication field, which is a bitmap with 14 bits and is used for indicating the attribute of each symbols within the reference time-frequency resource. For example, two PDSCHs (911 and 912) are transmitted in a DL subband (910): a first PDSCH (PDSCH 1, 911) is located in symbol #4˜#6, and a second PDSCH (PDSCH 2, 912) is located in symbol #10˜#13. There may be additional inter-subband interference for uplink transmission in a UL subband (820) on symbols #4˜#6, #10˜#13. Thus, the bitmap may be set to ‘00011100011110’, where ‘1’ means the power of an uplink transmission overlapping with corresponding sub-block need to be further adjusted.

In another embodiment, more than one resource indication fields are included in the group-common DCI. Each of the resource indication field indicates a group of resource, and corresponds with a set of power control parameters. For example, referring to FIG. 9, different DL transmissions in DL subband may cause different interference to uplink transmission in UL subband. For example, a DL transmission (e.g., PDSCH 1, 911) may cause a higher interference according at least one of the following factors: the DL transmission is closer to UL subband in the frequency domain, or has wider bandwidth, or the transmit power is greater, etc. The power of uplink transmission on the same symbols of PDSCH1 requires a higher power adjustment amount. On the other hand, the uplink transmission on symbols corresponding to PDSCH 2 (912) may adjust the relatively smaller power. When an uplink transmission only on the other symbols without DL transmission, no additional power adjustment is required.

In some implementations, referring to Table 8, the Group common DCI may contain two resource indication domains. It is agreed that the first resource indication domain corresponds to the set of the first power adjustment amount, and the second resource indication domain corresponds to the set of the second power adjustment amount, occupying 14 bits.

In some implementations, when an uplink transmission overlaps with more than one groups of resource, for example, the UE can calculate uplink transmission power according to different power control parameters, respectively, and a highest power may be used for the uplink transmission.

In some implementations, when an uplink transmission overlaps with more than one groups of resource, for example, the UE can calculate uplink transmission power according to different power control parameters, respectively, and the set of power control parameters corresponding to the resource group with higher resource overlapping ratios may be used for determining the power of the uplink transmission. For the non-liming example as shown in FIG. 9, the uplink transmission (i.e., PUSCH, 921) overlaps with the first resource group by one symbol, and it overlaps with the second resource group by two symbols. Thus, the power control parameters set corresponds to the second resource group is used for determining the power of the uplink transmission.

TABLE 8
Example of relationship between resource indicated
by RI field and power control parameters set

| Resource indication field in GC-DCI | power control parameters set |
|---|---|
| 0001110 0000000 | {P0, alpha}#1 |
| 0000000 0011110 | {P0, alpha}#2 |

Various embodiments present methods for uplink transmission power control for counteracting inter-subband interference. The method can effectively counteract the inter-subband interference, and flexibly match the requirements of coverage enhancement and capacity increase.

In some embodiments, measurement can be used for obtaining the interference quantity.

In some embodiments, the network may configure a plurality of measurement objects for a UE. The network may configure a plurality of channel state information (CSI) reports for the UE. The network may configure that a measurement object may be associated with a CSI report. A measurement object may be associated with more than one CSI reports and vice versa.

The configuration of the measurement object may include a plurality of resources. The UE may measure the configured resources to obtain the measurement results. More specifically, the UE may measure all the plurality of resources of the measurement object to obtain the measurement results. Additionally, the UE may report the measurement result according to the configuration of the CSI report.

The configuration of the measurement object may include at least one of the following: the resource for received signal strength indicator (RSSI) measurement, the resource for reference signal received power (RSRP) measurement, the resource for signal to noise and interference ratio (SINR) measurement and the resource for reference signal received quality (RSRQ) measurement, the resource for reference signal-signal to noise and interference ratio (RS-SINR) measurement, the resource for CSI measurement, and/or the resource for channel quality indicator (CQI) measurement.

The resource for measurement may be a reference signal or a physical resource. The reference signal may include at least one of the following: SRS, SSB, and/or CSI-RS.

The configuration of a reference signals may include at least one of the following: the time domain resource, frequency domain resource, the number of ports, transmission comb, resource type, the number of repetitions, sequence index, spatial relation information, and/or etc. The time domain resource may include at least one of the occupied symbol(s) and occupied slot(s) (e.g., slot index, slot offset and period). The frequency domain resource may include at least one of the following: the starting PRB, bandwidth, occupied RE in a RB, frequency hopping, and/or etc. The transmission comb may include at least one of comb offset and cyclic shift, and/or the number of comb. Additionally, the configuration of a reference signal may include serving cells, BWP index, and/or sub-carrier spacing.

The configuration of the physical resource may include at least one of the time domain resource, frequency domain resource, and/or serving cell. The plurality of physical resources may be in the different serving cells. The plurality of reference signals may be in the different serving cells.

The resource for measurement may be periodic resource, semi-persistent resource or aperiodic resource. The periodic resource may occur periodically after configuration. The semi-persistent resource may be activated or deactivated by medium access control control element (MAC CE). The semi-persistent resource may occur periodically after activation until it is deactivated by MAC CE. The MAC CE may include at least one of the following: the measurement object information (e.g., measurement object index), serving cell information (e.g., serving cell index), resource type (e.g., reference signal or physical resource), and/or the resource information (e.g. resource index) to indicate which resource is activated or deactivated. That is to say the information bits in the MAC CE may indicate at least one of the measurement object index, serving cell index, resource type, and/or resource index. For example, the configured resource in the measurement object includes SRS and physical resource for RSSI. Then the information bit with value ‘0’ may indicate the SRS and the information bit with value ‘1’ may indicate the physical resource for RSSI. Additionally, the MAC CE may include a field for indicating the activation or deactivation. For example, the field with value ‘1’ may indicate that indicated resource is activated and the field with value ‘0’ may indicate that the indicated resource is deactivated.

The aperiodic resource may be triggered by a downlink control information (DCI). The network may configure a time offset for each of the plurality of resource (e.g., reference signal or physical resource). The time offset may be between the slot (or other time unit) containing the DCI that triggers the resource (e.g., reference signal or physical resource) and the slot (or other time unit) in which the resource (e.g., reference signal or physical resource) is transmitted. A DCI may trigger one or more of the plurality of resources of the measurement object. For example, the measurement object may include 4 resources. The network configures the time offset for the first resource, the second resource, the third resource and the fourth resource may be 3 slot, 6 slot, 4 slot, 3 slot, respectively. When the DCI triggering the resource is transmitted on slot 1, the first resource, the second resource, the third resource and the fourth resource triggered by the DCI are transmitted on slot 4, slot 7, slot 5 and slot 4, respectively.

In some embodiments, the network may configure a plurality of trigger states for the UE. A trigger state may be associated with a CSI report. When a DCI indicates a trigger state, the CSI report associated with the trigger state is triggered. The trigger state may further indicate one or more resources from the plurality of resources of the measurement object. The UE may measure the resource indicated by the trigger state to obtain the measurement results and report the measurement results by using the triggered CSI report.

For a CSI report, the network may configure at least one of the following: the report type, PUCCH resource, report quantity, reported sub-bands, the number of the reported resources, the number of the reported serving cells, and/or etc.

The report type for a CSI report may include periodic report, semi-persistent report on PUSCH, semi-persistent report on PUCCH, and/or aperiodic report.

The configured PUCCH resource may be used to carry the CSI information of the CSI report. For the periodic report or semi-persistent report, the network may configure at least one of the period and/or the offset.

The report quantity may include at least one of the following: L1-RSRP, SRS-RSRP, RSSI, RSRQ, and/or SINR. The UE may report the corresponding measurement results. For example the configured report quantity is SRS-RSRP. The UE measures the configured resource and obtain the RSRP. Then the UE reports the obtained RSRP for the CSI report.

A BWP or a carrier may include a plurality of sub-bands. Each sub-band may include a plurality of RBs. The reported sub-bands may indicate for which sub-bands the UE may report CSI.

In some embodiments, the network may configure the total number of the resources reported by the UE for the CSI report. For example, the number of the reported resources is N. Then the UE may report the measurement results of the N resources among the plurality of resources of the associated measurement object.

In some embodiments, the network may configure the total number of the resource reported by the UE for each serving cell for the CSI report. For example, the number of the reported resources per cell is N. Then, for each serving cell, the UE may report the measurement results of the N resources among the plurality of resource of the associated measurement object.

The number of serving cells may indicate the total number of the serving cells reported by the UE for this CSI report.

Additionally, the network may configure that the UE report a plurality of highest or lowest measurement results. Based on the configuration of the measurement object, the UE may obtain a plurality of measurement results. There may be one or more measurement results for each of plurality of resources. Among the plurality of measurement results, the UE may only report some highest or lowest measurement results. More specifically, the UE may report N highest or lowest measurement results.

In accordance with the configuration of the CSI report, the CSI information may include a plurality of measurement results. The resource information corresponding to the measurement result may also be included. The resource information may include at least one of the resource index, the serving cell index of the resource, and the measurement object index of the resource. In some embodiments, the measurement results may be reported in terms of differential value. That is to say the UE may report a specific measurement result for the CSI report. Then the other measurement results for the CSI report is reported in terms of the differential value on top of the specific measurement result.

In some embodiments, the network may transmit a UL DCI (a DCI used for scheduling uplink transmission) scheduling a plurality of PUSCHs to the UE. The UL DCI may indicate that there are HARQ-ACK information bits (e.g., Type-1 codebook, Type-2 codebook, or Type-3 codebook) for transmission. The UE may not determine a PUCCH resource carrying the HARQ-ACK information for the PDSCH scheduled by the DL DCI (a DCI used for scheduling downlink transmission). The UE may generate the HARQ-ACK information according to the indication of UL DCI. The UE may multiplex the HARQ-ACK information bits in the second PUSCH of the plurality of PUSCHs if the plurality of PUSCHs include two PUSCHs. The UE may multiplex the HARQ-ACK information bits in the penultimate PUSCH of the plurality of PUSCHs if the plurality of PUSCHs include more than two PUSCHs.

The present disclosure describes methods, apparatus, and computer-readable medium for wireless communication. The present disclosure addressed the issues with cross-link interference. The methods, devices, and computer-readable medium described in the present disclosure may facilitate the performance of wireless communication by controlling transmission power, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments.

One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
performing, by a user equipment (UE), transmission power control for uplink (UL) transmission by:
receiving, by the UE, a message corresponding to the transmission power control;
determining, by the UE, a power control parameter according to the message; and
transmitting, by the UE, the UL transmission with a transmission power according to the power control parameter.

2. A method for wireless communication, comprising:
configuring, by a base station, transmission power control for uplink (UL) transmission by:
transmitting, by the base station to a user equipment (UE), a message corresponding to the transmission power control, so that the UE is configured to determine a power control parameter according to the message; and
receiving, by the base station from the UE, the UL transmission with a transmission power according to the power control parameter.

3. The method according to claim 1, wherein:
the power control parameter comprises one of the following: a power control parameter set, a power adjustment factor, or a maximum power limit; and
the power control parameter set comprises at least one of the following: an open-loop power control parameter set, or a closed-loop power control parameter set.

4. (canceled)

5. The method according to claim 1, wherein:
the message corresponding to the transmission power control comprises at least one of the following: a radio resource control (RRC) message, a medium access control (MAC) layer signaling, or a downlink control information (DCI) message.

6. The method according to claim 5, wherein:
the message comprises at least one configuration parameter comprising at least one of the following: a downlink (DL) subband bandwidth, a DL transmission power, a frequency offset, an adjacent channel leakage power ratio (ACLR), an adjacent channel selectivity (ACS), an adjacent channel interference power ratio (ACIR), an interference quantity leaking from a reference point, a decreasing interference quantity per frequency unit, or a ratio between a frequency resource of the UL transmission and a frequency resource of the UL subband.

7. (canceled)

8. The method according to claim 6, wherein:
the UE derives an interference quantity for the UL transmission based on the at least one configuration parameter in the message; and
the UE determines the power control parameter according to the interference quantity for the UL transmission.

9. The method according to claim 8, wherein, when the UE derives the interference quantity for the UL transmission based on the at least one configuration parameter in the message:
the UE derives the interference quantity for the UL transmission based on at least one interference quantity at at least one reference point, at least one decreasing interference quantity per frequency unit corresponding to the at least one reference point, and at least one offset frequency unit between the UL transmission and the at least one reference point.

10-13. (Canceled)

14. The method according to claim 1, wherein:
the message corresponding to the transmission power control comprises a mapping between a plurality of resource set and a plurality of power control parameter; and
the mapping is a one-to-one mapping.

15. (canceled)

16. (canceled)

17. (canceled)

18. The method according to claim 1, wherein:
the message corresponding to the transmission power control comprises a field indicating whether the UE adjusts the transmission power of the UL transmission;
the message comprises a DCI format or a random access response (RAR) UL grant; and
the field comprises a 1-bit field.

19. (canceled)

20. (canceled)

21. The method according to claim 1, wherein:
the message corresponding to the transmission power control comprises at least one indication field, wherein each indication field of the at least one indication field indicates that a group of resource corresponding to the indication field is mapped with a transmission power adjustment.

22-26. (canceled)

27. The method according to claim 2, wherein:
the power control parameter comprises one of the following: a power control parameter set, a power adjustment factor, or a maximum power limit; and
the power control parameter set comprises at least one of the following: an open-loop power control parameter set, or a closed-loop power control parameter set.

28. The method according to claim 2, wherein:
the message corresponding to the transmission power control comprises at least one of the following: a radio resource control (RRC) message, a medium access control (MAC) layer signaling, or a downlink control information (DCI) message.

29. The method according to claim 28, wherein:
the message comprises at least one configuration parameter comprising at least one of the following: a downlink (DL) subband bandwidth, a DL transmission power, a frequency offset, an adjacent channel leakage power ratio (ACLR), an adjacent channel selectivity (ACS), an adjacent channel interference power ratio (ACIR), an interference quantity leaking from a reference point, a decreasing interference quantity per frequency unit, or a ratio between a frequency resource of the UL transmission and a frequency resource of the UL subband.

30. The method according to claim 29, wherein:
the UE derives an interference quantity for the UL transmission based on the at least one configuration parameter in the message; and
the UE determines the power control parameter according to the interference quantity for the UL transmission.

31. The method according to claim 30, wherein, when the UE derives the interference quantity for the UL transmission based on the at least one configuration parameter in the message:
the UE derives the interference quantity for the UL transmission based on at least one interference quantity at at least one reference point, at least one decreasing interference quantity per frequency unit corresponding to the at least one reference point, and at least one offset frequency unit between the UL transmission and the at least one reference point.

32. The method according to claim 2, wherein:
the message corresponding to the transmission power control comprises a mapping between a plurality of resource set and a plurality of power control parameter; and
the mapping is a one-to-one mapping.

33. The method according to claim 2, wherein:
the message corresponding to the transmission power control comprises a field indicating whether the UE adjusts the transmission power of the UL transmission;
the message comprises a DCI format or a random access response (RAR) UL grant; and
the field comprises a 1-bit field.

34. The method according to claim 2, wherein:
the message corresponding to the transmission power control comprises at least one indication field, wherein each indication field of the at least one indication field indicates that a group of resource corresponding to the indication field is mapped with a transmission power adjustment.

35. An apparatus comprising:
a memory storing instructions; and
at least one processor in communication with the memory, wherein, when the at least one processor executes the instructions, the at least one processor is configured to cause the apparatus to perform transmission power control for uplink (UL) transmission by:
receiving a message corresponding to the transmission power control;
determining a power control parameter according to the message; and
transmitting the UL transmission with a transmission power according to the power control parameter.

36. An apparatus comprising:
a memory storing instructions; and
at least one processor in communication with the memory, wherein, when the at least one processor executes the instructions, the at least one processor is configured to cause the apparatus to configure transmission power control for uplink (UL) transmission by:
transmitting, to a user equipment (UE), a message corresponding to the transmission power control, so that the UE is configured to determine a power control parameter according to the message; and
receiving, from the UE, the UL transmission with a transmission power according to the power control parameter.
